(19) United States
(12) Patent Application Publication
(10) Pub. No.: US 2024/0110855 A1
(43) Pub. Date: Apr. 4, 2024

(54) Top Loading Testing Method and Device for Blow Molded Containers

(71) Applicant: Delta Engineering bvba, Ophasselt (BE)

(72) Inventor: Danny de Bruyn, Ophasselt (BE)

(21) Appl. No.: 18/477,704

(22) Filed: Sep. 29, 2023

(30) Foreign Application Priority Data
Sep. 30, 2022 (NO) 20221046

(51) Int. Cl. G01N 3/08

(52) U.S. Cl. CPC G01N 3/08; G01N 2203/0019

(57) ABSTRACT

A method and device for determining the compliance of blow molded containers with respect to a requested top load performance is disclosed. The height of a blow molded containers is determined, and a measuring head is connected to apply an increasing force onto the top of the blow molded container. The compression of the blow molded container is continuously measured along with the force applied. The application of the force is terminated before a non-linear correlation between force and compression is recorded and an accept or non-accept signal is generated by comparison with stored data.

### BACKGROUND

The disclosed embodiments concern a method for the top load testing of blow molded containers, and further to a related device.

Top load testing of blow molded bottles and other containers is essential for providing bottles and containers which are resistant to deformation when placed on top of each other. More businesses than ever are focused on protecting the environment by reducing overall packaging and making it more recyclable. Innovation through new materials and improved packaging design are contributing greatly to light-weighting and sustainability initiatives, but critically they must do this without compromising a container's overall strength or performance. Top-load testing is therefore a key method for performing quality control of blow molded bottles and other containers.

Top load testing is sometimes referred to as column-crush, vertical load resistance or axial force resistance. Top load testing involves applying a downwards compressive force to a packaging container and measuring its resistance to deformation.

U.S. Pat. No. 6,473,169 B1 discloses an integrated leak and vision inspection system that accurately and efficiently inspects a container for manufacturing defects. The system provides a series of visual inspection stations with cameras and lighting that are integrated onto a rotary inspection system for on-line inspection of containers. An additional feature of the leak and vision inspection system is disclosed, wherein the container can be tested for top load deflection of containers. A top load (vertical) force is applied to the container. If the container crushes or deflects under the vertical force, a sensor signal is generated and the container is rejected. The top load deflection test is a destructive test and is more time consuming than non-destructive tests performed at the visual inspection stations. The productivity of the rotary inspection system for on-line inspection of containers is therefore reduced if the top load deflection testing is included.

IN341519004 S and IN252613 S disclose top load testers suitable for top load testing of blow molded bottles and other containers. The container has to be inserted manually in the top load testers and testing of a continuous flow of bottles or containers is not feasible.

It is therefore a need for a top load tester suitable for fast inline testing of a continuous flow of bottles or containers right after their manufacturing in a blow molding machine.

### SUMMARY

Provided herein is a method for high voltage leak testing which does not increase the amount of negative charges on the outside of blow molded plastic containers.

According to the disclosure, a method for determining the compliance of blow molded containers with respect to a requested top load performance is provided. The method comprises several steps, of which the first part is well known from mechanical testing of blow molded containers. In the first part the height of a blow molded container is determined. Thereafter the measuring head is connected to the top of the blow molded container. The measuring head is designed to start pressing to the top of the blow molded container. The force applied by the press leads to the compression of the blow molded container. Force and compression are continuously measured. When the force is increased the compression is increased. In the beginning a linear correlation between force and compression is recorded. When the force is increased beyond the linear range, the blow molded container is damaged and the relation between force and compression is no longer linear.

Additionally, the application of the force may be terminated before a non-linear correlation between force and compression is recorded. Due to the termination of force the blow molded container is not damaged and can be used as packaging unit after the test. In order to decide if a blow molded container complies with respect to a requested top load performance, the linear correlation between force and compression is compared with stored data for the correlation between force and compression of acceptable containers. In practice the stored data provide a minimum and maximum slope of the force/compression relation for a pre-set time, depending from parameters such as material type, wall thickness and height of the blow molded container. If the blow molded container complies with the pre-set requirements, an accept signal is generated and the blow molded container is not damaged and can be used as packaging unit. If the blow molded container does not comply with the pre-set requirements a non-accept signal is generated which implies the disposal of the blow molded container.

In a preferred embodiment, the width and depth of the container are determined in addition to its height.

In another embodiment, the typical duration of the linear correlation between force and compression is measured by increasing the force beyond the linear range. The duration is added to the stored data and may be used by a control unit to run different types force application combined with compression measurement.

In another embodiment, the application of the force is terminated after less than 50% of the typical duration, more preferred less the 25% and most preferred less than 10%. The shorter the application of the force, the higher is the rate of measurement and the faster the distinguishing between acceptable and non-acceptable blow molded containers. Industrially highly attractive rates of measurements do not exceed 0.1 seconds, but 0.5 seconds or 1 second might still be attractive. The larger a blow molded container is, the more time for determining its compliance with respect to a requested top load performance is acceptable.

In yet another embodiment, the application of the force is not terminated below 50% of the typical duration. Some types of blow molded container may be made of expensive material or may be challenging to recycle in-house and thereby re-use the material. In such cases it is of considerable interest not to dispose containers, which are useful but receive a non-accept signal. Prolonged application of the force provides more exact data and thus reduces the number of false non-accept signals. A reduction to about zero is highly appreciated in such cases.

In another embodiment, the method is performed with filled blow molded containers or with filled and sealed blow molded containers. In most cases the method will be used for empty containers, which frequently just have been blow molded. However, in some cases the filled goods have an influence on the top load, for instance by partial migration into the walls of the blow molded container, which may lead to a softening effect. In such cases it may be useful to perform the top load testing with filled blow molded containers or with filled and sealed blow molded containers.

Also disclosed herein is a device for performing the method for determining the compliance of blow molded containers with respect to a requested top load performance. The device may comprise a control unit and may be designed for in-line testing of a continuous stream of blow molded containers from a blow molding machine.

### BRIEF DESCRIPTION OF THE DRAWINGS

Below, the invention will be descried in further detail in the form of non-limiting exemplary embodiments illustrated by drawings, wherein:

FIG. 1 shows a blow molded container;

FIG. 2 shows a measuring head connected to a blow molded container;

FIG. 3 shows a typical correlation of force/compression with a linear and non-linear part; and

FIG. 4 shows a typical range of stored data with a minimum and maximum slope of the force/compression relation.

### DETAILED DESCRIPTION

Certain means and devices described herein for performing steps of the inventive method are not described in detail herein since they are somewhat conventional in this technical field. For example, the disclosed embodiments may use elements such as actuators for moving elements and containers; contacting and non-contacting length and thickness measurement equipment, like micrometers, calipers or lasers; force application equipment, like arms, plungers and pistons; sensor(s) for measuring properties; receiver(s) for receiving measurements or other data transmitted by another element; processor(s) for calculating and comparing data; data storage; display unit(s) for displaying data; measurements and instructions; and communication lines between such elements. The novelty and inventiveness of the disclosed method and device are inherent in the relationships and the specific way with which means and devices are combined and used.

FIG. 1 shows a blow molded container (1). The height (2) of the blow molded containers (1) is indicated, as well as its wall thickness (3). The blow molded container (1) may be manufactured of different materials, each of which influences the force/compression data.

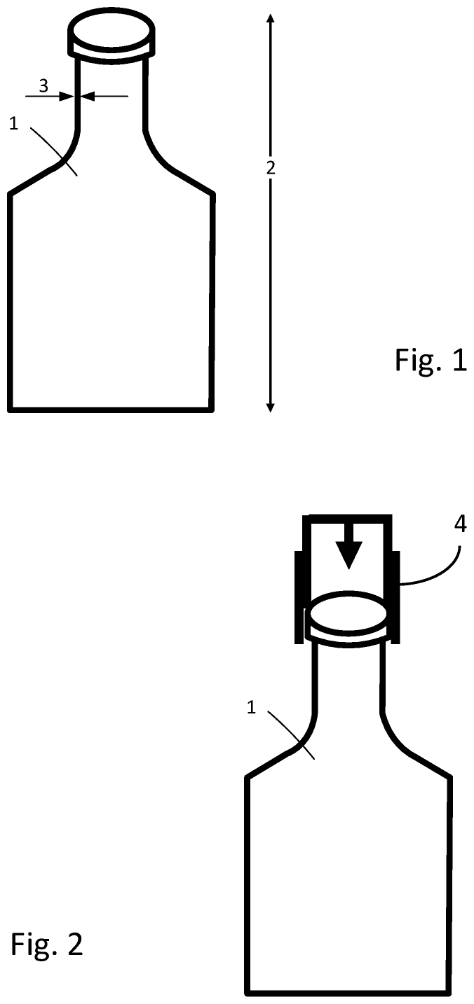

FIG. 2 shows a measuring head (4) connected to a blow molded container (1). The head (4) applies an increasing force to the blow molded container (1) by pressing a movable connection part of the head (4) with increasing force onto the top of the blow molded container (1).

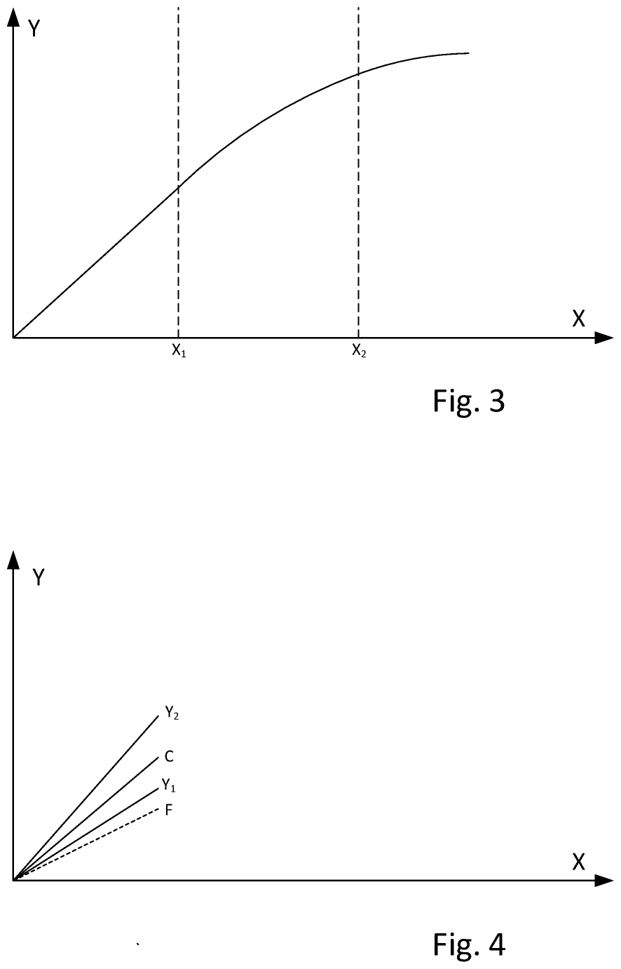

FIG. 3 shows a plot of a typical correlation of force (Y) to compression (X) with a linear and non-linear part. X₁ is a compression within the linear part, X₂ is a compression within the non-linear part. In the linear part the blow molded container (1) is only slightly or intermediately compressed and the compression is reversible. In the non-linear part the blow molded container (1) is severely compressed, and the compression is not reversible.

FIG. 4 shows a plot of different correlations of force (Y) to compression (X). The plot shows a typical range of stored data with a minimum (Y₁) and maximum (Y₂) slope of the force/compression correlation. Blow molded containers (1) shown in FIG. 1 are initially only slightly compressed and it is this initial part of the force/compression relation, which is instrumental in the inventive embodiments described herein. (C) shows the force/compression relation for an acceptable container and (F) for a non-acceptable container.

The method and instrument utilize this information and are configured to first determine a height of a blow molded container (1), then connect the container (1) with the top of a measuring head (4). The measuring head applies a force (F) onto the top of the blow molded container (1) and continuously measures the compression of the blow molded container (1). The head (4) increases the force (F) applied onto the top of the blow molded container (1) and records the correlation between force and compression, which is initially linear. The application of the force is then terminated while the linear correlation between force and compression is recorded. The linear correlation between force and compression is compared with stored data for the correlation between force and compression of acceptable containers. An accept or non-accept signal is generated from the analysis of the correlation data, and thereafter containers within the force/compression correlation of acceptable containers can be kept, and containers within force/compression correlation outside that of acceptable containers are disposed.

The devices has a control unit, data storage and communication channels configured to initiate and perform the predetermined steps.

The data stored can comprise a typical or standard duration of the linear correlation between force and compression for containers of various dimensions.

Often the application of the force is terminated after less than 50% of the typical duration, and more preferably after less than 10% of the typical duration.

In some embodiments, the application of the force is terminated after less than 1 second. In some embodiments, application of the force is terminated after less than 0.1 seconds. In some embodiments, application of the force is terminated after less than 0.5 seconds.

In some embodiments, the container (1) is filled during the above described procedure. In some embodiments, the container (1) is filled and sealed during the above described procedure.

It should be noted that the drawings only present the principles of the present invention and that the scale of the drawings may deviate significantly from real-life embodiments.

What is claimed is:

1. A method for determining the compliance of blow molded containers with a requested top load performance, comprising the steps of:
(a) determining a height of at least one blow molded container (1);
(b) connecting the at least one blow molded container (1) with the top of at least one measuring head (4) configured to apply a force (F) onto the top of the blow molded container (1) and to continuously measure the compression of the blow molded container (1);
(c) increasing the force (F) applied onto the top of the blow molded container (1); and
(d) recording an initially linear correlation between force and compression, wherein
the application of the force is terminated while a linear correlation between force and compression is recorded,
the linear correlation between force and compression is compared with stored data for the correlation between force and compression of acceptable containers, and
an accept or non-accept signal is generated based on the comparison.

2. The method according to claim 1, comprising the step of determining a width and a depth of the container in step (a).

3. The method according to claim 2, wherein a typical duration of the linear correlation between force and compression is comprised by the stored data.

4. The method according to claim 1, wherein a typical duration of the linear correlation between force and compression is comprised by the stored data.

5. The method according to claim 4, wherein the application of the force is terminated after less than 50% of the typical duration.

6. The method according to claim 4, wherein the application of the force is terminated after less than 10% of the typical duration.

7. The method according to claim 1, wherein the application of the force is terminated after less than 1 second.

8. The method according to claim 1, wherein the application of the force is terminated after less than 0.1 seconds.

9. The method according to claim 1, wherein the application of the force is terminated after less than 0.5 seconds.

10. The method according to claim 4, wherein the application of the force is not terminated below 50% of the typical duration in order to reduce a quantity of false non-accept signals to about zero.

11. The method according to claim 1, wherein the at least one of the at least one blow molded containers (1) is filled.

12. The method according to claim 1, wherein the at least one of the at least one blow molded containers (1) is filled and sealed.

13. A device for determining compliance of blow molded containers (1) with a requested top load performance, comprising the following:
a means for determining a height of at least one blow molded container (1) having a top;
a measuring head (4) configured for
connection with a top of at least one blow molded container (1),
to apply a force onto the top of the blow molded container (1),
continuously measuring compression of the blow molded container,
increasing the force applied onto the top of the blow molded container (1), and
recording an initially linear correlation between force and compression, wherein
the device is configured to terminate the force applied onto the top of the container (1) before the recording of a non-linear correlation between force and compression,
the device is configured to compare the linear correlation between force and compression with stored data for the correlation between force and compression of acceptable containers, and
the device is configured to generate an output of an accept or non-accept signal.

14. The device according to claim 13, comprising a control unit, wherein the device is configured for in-line testing of a continuous stream of blow molded containers (1) from a blow molding machine.
